(19) United States
(12) Patent Application Publication
(10) Pub. No.: US 2026/0175704 A1
(43) Pub. Date: Jun. 25, 2026

(54) ELECTRIC MOTOR VEHICLE AND CORRESPONDING CONTROL METHOD

(71) Applicant: Maserati S.p.A., Modena (IT)

(72) Inventors: Alexis Adrien Joseph MARCHYLLIE, Modena (IT); Carlo CAMPANALE, Modena (IT)

(21) Appl. No.: 19/126,300

(22) PCT Filed: Oct. 17, 2023
(86) PCT No.: PCT/IB2023/060441

§ 371 Date: May 1, 2025

(30) Foreign Application Priority Data
Nov. 3, 2022 (IT) 102022000022602

(51) Int. Cl. B60L 50/51; B60L 3/00; B60W 10/02; B60W 10/06; B60W 10/08

(52) U.S. Cl. CPC B60L 50/51; B60L 3/003; B60W 10/02; B60W 10/06; B60W 10/08; B60L 2240/421

(57) ABSTRACT

An electric drive motor vehicle includes an axle and a vehicle communication network. The axle includes two inverter devices coupled to respective electric motors to drive the respective drive wheels. Each inverter device includes a respective electronic control unit. The two electronic control units exchange messages via the vehicle communication network. The first electronic control unit detects malfunctioning in the respective inverter device and/or in the respective electric motor. If a malfunctioning is detected, the first electronic control unit switches from a normal operating state to a safe operating state and transmits a safe-state request message via the vehicle communication network. The second electronic control unit receives the safe-state request message and, in response to the safe-state request message being received, switches from the normal operating state to the safe operating state.

### FIELD OF THE INVENTION

The present invention generally refers to electric drive motor vehicles equipped with a drive axle or driving axle (also referred to as “eAxle”) that includes a pair of electric propulsion units (also referred to as “eDrive” or “eDrive sub-systems”). Each electric propulsion unit includes a driving inverter device and an electric motor connected to a drive wheel of the motor vehicle.

Specifically, the present invention refers to a method for controlling the two propulsion units of the axle in a synchronized and/or coordinated manner, particularly for controlling the two inverters.

### PRIOR ART

Electric drive motor vehicles equipped with two propulsion units mounted on the same axle and each connected to a drive wheel are known in the art. For example, document U.S. Pat. No. 5,481,460 discloses a controller for an electric vehicle in which the left and right drive wheels are driven by respective electric motors.

In such vehicles, it is necessary to synchronize and/or coordinate the operation of the two electric motors mounted on the same axle, and in particular synchronize and/or coordinate the driving of the respective inverters, when a malfunctioning is detected (for example, an error or a failure) in one of the inverters or in one of the electric motors.

A first known solution for synchronizing and/or coordinating the operation of two inverters with a sufficiently high frequency for automotive applications, particularly for high-performance vehicles, consists of the implementation of a dedicated communication channel between the two inverters. However, this solution requires the implementation of specific hardware, such as a Zip-wire communication channel, with a consequent increase in the complexity and cost of the system, as well as an increase in possible sources of malfunctioning.

Another known solution for synchronizing and/or coordinating the operation of the two inverters instead involves the implementation of a further electronic control unit (in addition to the two electronic control units already provided in the two inverters), also called “Hybrid Control Unit” or “HCU”, which is connected to the two inverters via a vehicle network and manages their operation. However, this solution determines an increase in communication times between the inverters and therefore an increase in the reaction times of the control system, and is therefore unsuitable for application to high-performance vehicles, in which the electric motors operate at high speed and develop a high torque and any delay in the synchronization and/or coordination of the respective inverters can lead to a loss of vehicle stability.

Therefore, electric drive motor vehicles are desirable, equipped with two propulsion units mounted on the same axle, and equipped with an improved inverter synchronization and/or coordination system.

### OBJECT OF THE INVENTION

The object of the present invention is to provide a motor vehicle equipped with such an improved electric drive system, which allows rapid synchronization and/or coordination of the operation of the two drive axle inverters, particularly when a malfunctioning is detected in one of the inverters or in one of the electric motors, and it is therefore applicable to high-performance vehicles.

### SUMMARY OF THE INVENTION

According to a first aspect, the invention has as its subject an electric drive motor vehicle comprising an axle and a vehicle communication network. The axle comprises a first inverter device coupled to a first electric motor to drive a first drive wheel and a second inverter device coupled to a second electric motor to drive a second drive wheel. The first inverter device comprises a first electronic control unit and the second inverter device comprises a second electronic control unit. The first electronic control unit and the second electronic control unit are coupled to the vehicle communication network and are configured to exchange messages via the vehicle communication network. The first electronic control unit is configured to detect a malfunctioning in the first inverter device and/or the first electric motor and, in response to a malfunctioning being detected, switch from a normal operating state to a safe operating state where the first electric motor is not active, and transmit a safe-state request message via the vehicle communication network. The second electronic control unit is configured to receive the safe-state request message via the vehicle communication network and, in response to the safe-state request message being received, switch from a normal operating state to a safe operating state where the second electric motor is not active.

As will appear in greater detail from the following description, the fundamental idea behind the present invention is to synchronize (and optionally coordinate) the switching to a safe-state of the two inverters that drive the drive wheels of the same vehicle axle, when one of the two inverters detects a malfunctioning or anomaly, through the use of a vehicle communication network.

In a preferred embodiment, the first electronic control unit is configured to carry out a control procedure in response to a malfunctioning being detected, and to switch to the safe operating state and transmit the safe-state request message if the control procedure confirms the presence of a malfunctioning.

In a preferred embodiment, the first electronic control unit is configured to switch from the normal operating state to a first safe operating state or to a second safe operating state as a function of the operating conditions of the first inverter device and/or the first electric motor sensed in the moment when the malfunctioning is detected.

In a preferred embodiment, the second electronic control unit is configured to switch from the normal operating state to the first safe operating state or the second safe operating state. The first electronic control unit is further configured to transmit via the vehicle communication network a state message that indicates which one of the first safe operating state and the second safe operating state the first electronic control unit has switched to. The second electronic control unit is further configured to receive the state message via the vehicle communication network and, in response to the state message being received, switch from the normal operating state to the same safe operating state indicated by the state message.

In a preferred embodiment, the first electronic control unit is configured to switch between the first safe operating state and the second safe operating state as a function of the operating conditions of the first inverter device and/or the first electric motor.

In a preferred embodiment, in the first safe operating state the first inverter device is driven such that all the switches of the half-bridges of the first inverter device are open.

In a preferred embodiment, in the second safe operating state the first inverter device is driven in such a way that all the high-side switches of the half-bridges of the first inverter device are closed and all the low-side switches of the half-bridges of the first inverter device are open, or all the low-side switches of the half-bridges of the first inverter device are closed and all the high-side switches of the half-bridges of the first inverter device are open.

In a preferred embodiment, the vehicle communication network comprises a Controller Area Network (CAN) type bus, optionally a motor vehicle propulsion control bus.

In a preferred embodiment, the second electronic control unit is configured to detect a loss of communication with the first electronic control unit via the vehicle communication network, and in response to a loss of communication being detected, switch from the normal operating state to the safe operating state.

In a preferred embodiment, the first electronic control unit comprises a hardware circuit configured to force the switching of the first electronic control unit from the normal operating state to the safe operating state in response to a critical failure taking place in the first electronic control unit.

According to a second aspect, the invention has as its subject a method for controlling a motor vehicle according to one or more embodiments. The method comprises:
detecting a malfunctioning in the first inverter device and/or in the first electric motor of the vehicle;
in response to a malfunctioning being detected, switching the first electronic control unit from a normal operating state to a safe operating state where the first electric motor is not active, and transmitting a safe-state request message from the first electronic control unit via the vehicle communication network;
receiving the safe-state request message at the second electronic control unit via the vehicle communication network; and
in response to the safe-state request message being received, switching the second electronic control unit from a normal operating state to a safe operating state where the second electric motor is not active.

### DETAILED DESCRIPTION OF THE INVENTION

Further features and advantages of the invention will emerge from the following description with reference to the attached drawings, provided purely by way of non-limiting example, wherein:

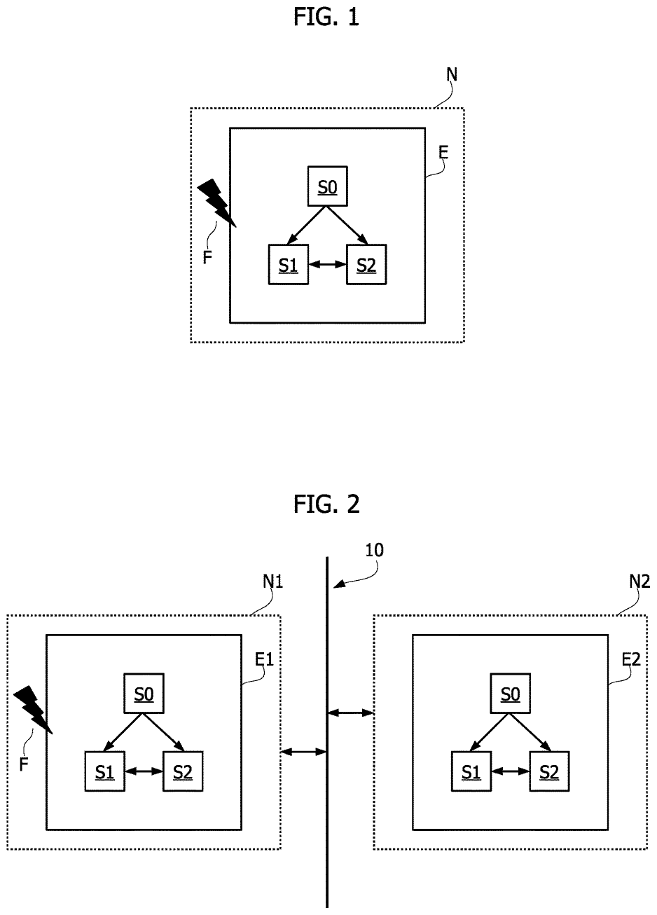

FIG. 1 is a block diagram of an inverter for the drive of an electric vehicle; and

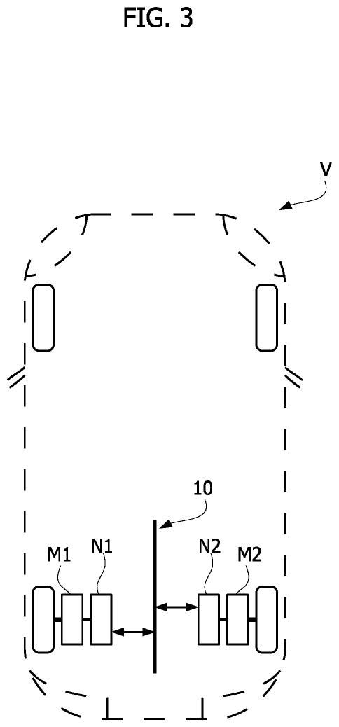

FIGS. 2 and 3 are block diagrams of a drive system of an electric vehicle comprising two electric propulsion units on the same axle.

In the figures attached here, corresponding parts are indicated with the same reference numbers.

As anticipated, one or more embodiments can be applied in the field of electric drive vehicles, in particular high-performance ones, equipped with an axle that comprises two electric propulsion units, each of which comprises an electric motor and an inverter. The invention relates to a method for synchronizing and/or coordinating the operation of the two inverters when a malfunctioning (for example, a failure or an error) is detected in one of the two inverters or in one of the two electric motors. The rapid synchronization and/or coordination of the operation of the two inverters in such cases helps to maintain the stability of the vehicle while driving.

FIG. 1 is a block diagram that illustrates the operation of the electronic control unit E (also called “Motor Control Processor” or “MCP”, possibly implemented with a microcontroller) of an inverter N that powers an electric motor of an axle of a motor vehicle. The control unit E of the inverter N normally operates in an operating state (or operation state) S0, i.e., a “normal” state which is used when no anomalies or malfunctioning in the system are detected. In response to the detection of a malfunctioning F by the control unit E, the control unit E switches to a safe operating state in which the inverter N is driven in order to remove the electrical power supply to the respective motor. Specifically, the control unit E can switch to a first safe operating state S1 or to a second safe operating state S2 as a function of the operating conditions of the system sensed in the moment when the malfunctioning F is detected. For example, the unit E can switch to the safe operating state S1 if the supply voltage of the inverter N is lower than a certain threshold (for example, equal to 60 V) and to the safe operating state S2 if the supply voltage of the inverter N is higher than this threshold. The two safe operating states S1 and S2 are distinguished as they correspond to different driving configurations of the inverter N. Specifically, the operating state S1 can correspond to a so-called “six switch open” or 6SO state, in which all six switches of the three half-bridges of the inverter N are in a high impedance condition (i.e., open). The operating state S2 can instead correspond to a so-called “three phase short” or 3PS state, in which all three low-side switches (or all three high-side switches) of the three half-bridges of the inverter N are in a low-impedance condition (i.e., closed) and all three high-side switches (or all three low-side switches) of the three half-bridges of inverter N are in a high-impedance condition (i.e., open), in such a way that the three phases of the electric motor are short-circuited at the same voltage. Furthermore, the control unit E can switch from one safe operating state to another (i.e., from S1 to S2 or vice versa) in response to a change in operating conditions (for example, if the supply voltage of the inverter N crosses the threshold value, or in response to a different trigger). In general, the control unit E of each inverter is equipped with a local control logic that allows switching between the operating states S0, S1 and S2 as a function of the possible detection of malfunctioning and/or operating conditions.

In some applications, an electric drive motor vehicle comprises two electric propulsion units (right and left) mounted on the same axle, one for each drive wheel, as illustrated in the diagram in FIG. 2. FIG. 2 is a block diagram illustrating some components of a motor vehicle according to the present invention. Specifically, FIG. 2 illustrates the electronic control unit E1 of the first inverter N1 and the electronic control unit E2 of the second inverter N2 (also called “Motor Control Processor” or “MCP”). In this case, it is necessary to implement communication between the two electronic control units E1 and E2 of the two inverters N1 and N2 in order to synchronize and/or coordinate their operation. In various embodiments, the control units E1 and E2 do not communicate via a dedicated communication channel (for example, Zip-wire), but are coupled to a vehicle communication bus or network 10 which may be the CAN (Controller Area Network) bus of the vehicle's propulsion system. Each control unit E1, E2 implements a control function for managing malfunctioning, and is configured to exchange CAN messages via the bus 10 (for example, by transmitting one or more broadcast messages or “frames”) for synchronizing and/or coordinating operation with the other control unit when a malfunctioning is detected. Specifically, the exchange of messages between the units E1 and E2 via (CAN) bus 10 can take place at a rather high speed, so as to ensure fast reaction times. For example, the exchange of messages between the left and right inverters can take place within a time limit of 2 ms.

When a malfunctioning F is detected in the inverter N1 (or in the electric motor coupled to it), the inverter N1 reacts by implementing a recovery mode as discussed in relation to FIG. 1, i.e., by switching from the normal operating state S0 to a safe operating state S1 or S2, as a function of the operating conditions of the inverter or electric motor detected at that time. At the same time, the control unit E1 transmits via the bus 10 a (broadcast) message requesting operation in a safe state (“Safe State Request” message, or briefly SSR message) which is received by the control unit E2 of the second inverter N2. Following the receipt of this message, the control unit E2 forces the switching of the second inverter N2 to a safe operating state, so as to ensure that there are no imbalances in the torque supplied by the two motors on the same axis, and allowing the stabilization of the vehicle within a short time (for example, 70 ms).

Specifically, if a malfunctioning is detected in one of the two propulsion units (i.e., in the inverter N1 or in the motor associated with it), the corresponding inverter N1 can perform a control procedure to confirm or not the presence of an error. This control procedure can be completed within a confirmation time T1, which can be in the order of 40 ms or less. Once the presence of the error has been confirmed, the inverter N1 switches to a safe operating state, S1 or S2, taking an execution time T3 for this purpose, which can be in the order of 12 ms or less. At the same time, as soon as the presence of an error is confirmed, inverter N1 transmits the SSR message via bus 10 so that it is received by the second inverter N2. When the second inverter N2 receives the SSR message from bus 10, it can validate the receipt of the message within a certain communication time T2 (for example, after a certain number of sampling intervals such as two sampling intervals), which can be in on the order of 10 ms or less. As soon as the SSR message is validated by the inverter N2, the control unit E2 forces the switching of the inverter N2 to a safe operating state, S1 or S2, taking an execution time T3 for this purpose, which can again be in the order of 12 ms or less. Considering the indicative values for the times T1, T2 and T3 discussed here, the present invention allows both inverters N1 and N2 (left and right) of the same axle to operate in a safe operating state within a total reaction time that can be in the order of 62 ms or less, starting from when a malfunctioning is detected in one propulsion unit or in the other.

In some embodiments, the control units E1 and E2 of the inverters N1 and N2 are configured to implement the synchronized switching to a safe operating state even in the event of a loss of communication between the two inverters and/or in the event of a critical failure in one of the control units. Specifically, each control unit E1, E2 can be configured to detect the loss of communication with the other control unit (for example, by implementing a watchdog function, i.e., by detecting the absence of signals emitted by the other control unit for a time exceeding a certain duration). In response to the loss of communication being detected, the control unit forces the switching of the operating state of the respective inverter to a safe operating state (S1 or S2), by choosing one or the other safe-state as a function of its internal logic. This function is also applicable in the event that a critical failure occurs in one of the control units: in this circumstance, a dedicated hardware circuit can force the faulty control unit to switch to a safe operating state, and if the failure is such that communication of the control unit via bus 10 is prevented, the other control unit will also switch to a safe operating state as soon as the loss of communication is detected.

In some embodiments, the SSR message exchanged between inverters N1 and N2 via bus 10 simply indicates the need to switch the operating state of the inverters to a safe operating state. The implementation of the recovery mode, as well as the choice of which safe-state (S1 or S2) has to be implemented, is dictated by the local logic of each inverter, independently of each other, and it is thus possible to achieve synchronization of the behavior of the two inverters. It has been noted, however, that the two safe operating states S1 (six-switch-open, 6SO) and S2 (three-phase-short, 3PS) of the inverters have different effects on the driving of the electric motors. Specifically, the 3PS state produces a negative torque on the drive shaft (and therefore also on the wheel connected to it, if the drive system does not have a drive disconnection system), whose value decreases as the engine speed increases. The 6SO state instead induces a back-EMF voltage whose value increases linearly as the engine speed increases. The 6SO state does not produce any torque on the drive shaft if the back-EMF voltage is lower than the inverter's DC-link voltage, i.e., lower than the voltage supplied by the vehicle's drive battery (for example, approximately 800 V); conversely, the 6SO state produces a torque on the motor shaft, whose value increases linearly as the engine speed increases, if it is implemented when the engine is running at a speed greater than the threshold speed at which the back-EMF voltage is greater than the inverter's DC-link voltage. Therefore, the implementation of a different safe operating state between the two inverters of the same axle (for example, the state S1 in the inverter N1 and the state S2 in the inverter N2, or vice versa) could lead, under certain conditions, to application of a different torque value to the two drive wheels, with the risk of causing destabilization of the vehicle while driving.

In general, it has been noticed that the rotation speed of the two electric motors (right and left) is almost the same for most of the driving time of the motor vehicle, so that in most cases where an inverter transmits an SSR message following the detection of a malfunctioning, the two inverters will switch to the same safe operating state (S1 or S2) even if the choice of the safe-state is independently entrusted to the internal logic of each inverter (i.e., when there is a synchronization of the activation of the safe-state, but not a replication or mirroring of the behavior between the two inverters, i.e., an actual coordination).

In some circumstances, however, it may happen that when a malfunctioning is detected, the two electric motors are running at different speeds, for example due to a wheel slipping or driving along a turn. In these cases, the different speed of the two motors could determine the implementation of two different safe operating states by the two inverters. In yet other circumstances, a failure may occur that prevents the implementation of the 6SO state by one of the two inverters, so that in the event of a request to implement a safe-state, this inverter would implement the 3PS state even at low speed, while the other inverter would implement the 6SO state. In various embodiments, therefore, the inverter that detects a malfunctioning not only communicates an SSR message requesting the other inverter to implement generically the recovery mode, but also communicates the type of safe operating state (S1 or S2) implemented. This function can be implemented by setting the value of a specific field of the CAN SSR message, or by transmitting a second (broadcast) message via bus 10 that conveys further information on the type of safe operating state implemented. In this way, the second inverter receives from bus 10 the request to switch to a safe operating state and the indication of which safe-state to implement, and the internal logic of the second inverter is “bypassed” to directly implement the safe-state requested by the first inverter. Thus, the behavior of the second inverter mirrors that of the first inverter, creating real coordination, and the application of different torque values to the two drive wheels is avoided.

FIG. 3 is a block diagram illustrating a motor vehicle V equipped with a system as described here, in which the axle (rear in this case, but possibly front) is provided with two inverters N1, N2 each of which controls a respective electric motor M1, M2 connected to a respective drive wheel of the vehicle.

The invention described here is advantageous as it allows to synchronize and/or coordinate the operation of two electric propulsion units mounted on the same axle of a motor vehicle in the event of detection of a malfunctioning, without the need to implement a dedicated communication channel between the two inverters (and therefore reducing the complexity and cost of the system, as well as the complexity and cost of packaging). The invention allows to obtain this synchronization and/or coordination of the inverters in a low reaction time, which is suitable for guaranteeing vehicle stability even in the event of high-performance vehicles, improving driving safety.

Of course, without prejudice to the principle of the invention, the construction details and the embodiments may vary widely with respect to what has been described and illustrated purely by way of example, without thereby departing from the scope of the present invention, as defined in the attached claims.

1. An electric drive motor vehicle, comprising:
an axle comprising a first inverter device coupled to a first electric motor to drive a first drive wheel, and a second inverter device coupled to a second electric motor to drive a second drive wheel, wherein said first inverter device comprises a first electronic control unit and said second inverter device comprises a second electronic control unit; and
a vehicle communication network;
wherein said first electronic control unit and said second electronic control unit are coupled to said vehicle communication network and are configured to exchange messages via said vehicle communication network;
and wherein said first electronic control unit is configured to:
detect a malfunctioning in said first inverter device and/or in said first electric motor; and
in response to the malfunctioning being detected, switch from a normal operating state to a safe operating state where said first electric motor is not active, and transmit a safe-state request message via said vehicle communication network;
and wherein said second electronic control unit is configured to:
receive said safe-state request message via said vehicle communication network; and
in response to said safe-state request message being received, switch from the normal operating state to the safe operating state where said second electric motor is not active.

2. The motor vehicle of claim 1, wherein said first electronic control unit is configured to:
carry out a control procedure in response to the malfunctioning being detected; and
switch to said safe operating state and transmit said safe-state request message if said control procedure confirms the presence of said malfunctioning.

3. The motor vehicle of claim 1, wherein said safe operating state includes a first safe operating state and a second safe operating sate, and wherein said first electronic control unit is configured to switch from said normal operating state to said first safe operating state or to said second safe operating state as a function of operating conditions of said first inverter device and/or of said first electric motor sensed in a moment when said malfunctioning is detected.

4. The motor vehicle of claim 3, wherein:
said second electronic control unit is configured to switch from said normal operating state to said first safe operating state or to said second safe operating state;
said first electronic control unit is configured to transmit via said vehicle communication network a state message that indicates which one of said first safe operating state and said second safe operating state said first electronic control unit has switched to; and
said second electronic control unit is configured to:
receive said state message via said vehicle communication network; and
in response to said state message being received, switch from said normal operating state to the same safe operating state indicated by said state message.

5. The motor vehicle of claim 3, wherein said first electronic control unit is configured to switch between said first safe operating state and said second safe operating state as a function of the operating conditions of said first inverter device and/or of said first electric motor.

6. The motor vehicle of claim 3, wherein in said first safe operating state said first inverter device is driven so that all the switches of half-bridges of the first inverter device are open.

7. The motor vehicle of claim 3, wherein in said second safe operating state said first inverter device is driven so that all high-side switches of half-bridges of the first inverter device are closed and all low-side switches of the half-bridges of the first inverter device are open, or all the low-side switches of the half-bridges of the first inverter device are closed and all the high-side switches of the half-bridges of the first inverter device are open.

8. The motor vehicle of claim 1, wherein said vehicle communication network-comprises a Controller Area Network, CAN, bus, preferably a propulsion control bus of the motor vehicle.

9. The motor vehicle of claim 1, wherein said second electronic control unit is configured to:
detect a loss of communication with said first electronic control unit via said vehicle communication network; and
in response to the loss of communication being detected, switch from said normal operating state to said safe operating state.

10. The motor vehicle of claim 1, wherein said first electronic control unit comprises a hardware circuit configured to force switching of said first electronic control unit from said normal operating state to said safe operating state in response to a critical failure taking place in said first electronic control unit.

11. A method of controlling a motor vehicle according to claim 1, the method comprising:
detecting said malfunctioning in said first inverter device and/or in said first electric motor;
in response to said malfunctioning being detected, switching said first electronic control unit from said normal operating state to said safe operating state where said first electric motor (M1) is not active, and transmitting said safe-state request message from said first electronic control unit via said vehicle communication network;
receiving said safe-state request message at said second electronic control unit via said vehicle communication network; and
in response to said safe-state request message being received, switching said second electronic control unit from said normal operating state to said safe operating state where said second electric motor is not active.
